(19) United States
(12) Patent Application Publication
(10) Pub. No.: US 2001/0032248 A1
(43) Pub. Date: Oct. 18, 2001

(54) Systems and methods for generating computer-displayed presentations

(76) Inventor: Richard H. Krafchin, New York, NY (US)

Correspondence Address: FISH & NEAVE, 1251 AVENUE OF THE AMERICAS, 50TH FLOOR, NEW YORK, NY, 10020-1105, US

(21) Appl. No.: 09/821,519

(22) Filed: Mar. 29, 2001

Related U.S. Application Data
(60) Provisional application No. 60/193,035, filed on Mar. 29, 2000.

(51) Int. Cl. G06F 15/16

(52) U.S. Cl. 709/206; 709/218

(57) ABSTRACT

Systems and methods for generating computer-displayed presentations are provided which may first be used to create a visual representation of a presentation using a presentation development tool. This visual representation may be converted into a meta code representation of the presentation. Next, Java script may be generated for the presentation. When the presentation is satisfactory, the presentation may be then be finalized by replacing conditional elements in the Java script with final elements, and then by moving the objects and scripts to a presentation server. Once finalized, the Java script may be sent to recipients as part of an ordinary email message. Upon receipt of the email, a recipient may view the contents of the presentation by opening the email in an ordinary fashion. A response form may be provided as part of the presentation to facilitate the viewer interacting with the presentation.

### CROSS REFERENCE TO RELATED APPLICATION

This application claims the benefit of United States Provisional Patent Application No. 60/193,035, filed Mar. 29, 2000, which is hereby incorporated by reference herein in its entirety.

### BACKGROUND OF THE INVENTION

This invention relates to the generation of computer-displayed presentations. More particularly, this invention relates to the generation of presentations that can be presented through email and Internet Web sites.

In recent years, electronic methods of generating still and animated presentations have gained widespread popularity. These presentations include various forms of communicating information such as advertisements, promotions, news bulletins, art work, entertainment displays, animations, instructional displays, etc. Some of these types of presentations have been presented on Internet Web sites and using email. For example, many Internet Web sites now use Macromedia Flash to present animated presentations showing various content. As another example, email has been used to transmit still-presentation advertisements that appear in a format similar to a still Web page.

One draw back to these types of presentations is that they typically require a great deal of effort to develop because of the difficulty in programming that is required. Additionally, many of these presentations require a viewer to have special software or Web-browser plug-ins (such as Macromedia Flash) running on the viewer's computer before the presentations can be viewed. Further still, animated versions of these presentations typically cannot be easily emailed because they are very large in size (and thus may be blocked by email size limits) and require special plug-ins at the email client.

It is, therefore, an object of the invention to provide systems and methods for generating computer-displayed presentations which overcome these and other limitations of the prior art.

### SUMMARY OF THE INVENTION

In accordance with this and other objects of the present invention, new systems and methods for generating computer-displayed presentations are provided. These systems and methods may first be used to create a visual representation of a presentation using a presentation development tool on an artist computer. This visual representation may then optionally be converted into a meta code representation of the presentation. After generating the meta code, or directly after creating the visual representation if desired, Java script, or any other suitable email-client-executable or browser-executable code, may be generated for the presentation. The visual representation, meta code, and Java script may then be saved to a storage medium coupled to the artist computer if desired.

When the presentation is satisfactory, the presentation may be finalized by replacing conditional elements in the Java script with final elements, by compiling the Java script into a “.HTM” file which is then compiled into an ordinary email message that is preferably Simple Mail Transfer Protocol (SMTP) compliant (See RFC-0821 from the Internet Engineering Task Force at www.ietf.org), by embedding certain portions of the presentation into the email (See RFC-2111 from the Internet Engineering Task Force at www.ietf.org), and then by moving objects and scripts associated with the presentation to a presentation server. Once finalized, the presentation may be sent to recipients as part of the ordinary email message over any suitable computer network.

Upon receipt of the email at a recipient's computer, a recipient may view the contents of the presentation by opening the email in an ordinary fashion. As the email is opened, the recipient's computer may retrieve components of the presentation from the presentation server over the computer network. Other components of the presentation may have been embedded in the email. The presentation may then be automatically presented to a user, and may include static image and/or graphics components, animated image and/or graphics components, video components, audio components, and any other suitable content.

Finally, a response form may be provided as part of the presentation to facilitate the viewer interacting with and submitting responses to the presentation. For example, if the presentation is an invitation to an event, the response form may facilitate the viewer indicating whether he or she can attend the event. As the viewer uses the response form, the viewer's responses may be uploaded to the presentation server and the content of the presentation that are presented to the viewer are preferably updated from the presentation server so that the user may continue to interact with the presentation and response form via the original email. The responses to the presentation may then viewed and analyzed by an administrator on an administrator computer.

### BRIEF DESCRIPTION OF THE DRAWINGS

The above and other objects and advantages of the invention will be apparent upon consideration of the following detailed description taken in conjunction with the accompanying drawings in which like reference characters refer to like parts throughout and in which:

FIG. 1 is a block diagram of a system that may be used to implement various embodiments of the present invention;

FIG. 2 is a flow diagram of a process that may be used to create and send a presentation in accordance with various embodiments of the present invention;

FIG. 3 is a flow diagram of a process that may be used to display and respond to a presentation in accordance with various embodiments of the present invention;

FIGS. 4-11 are illustrations of various screen displays that may be generated by a tool for creating presentations in accordance with various embodiments of the present invention; and

FIG. 12 is an illustration of a presentation as the presentation is being displayed to a recipient in accordance with various embodiments of the present invention.

### DETAILED DESCRIPTION OF THE PREFERRED EMBODIMENTS

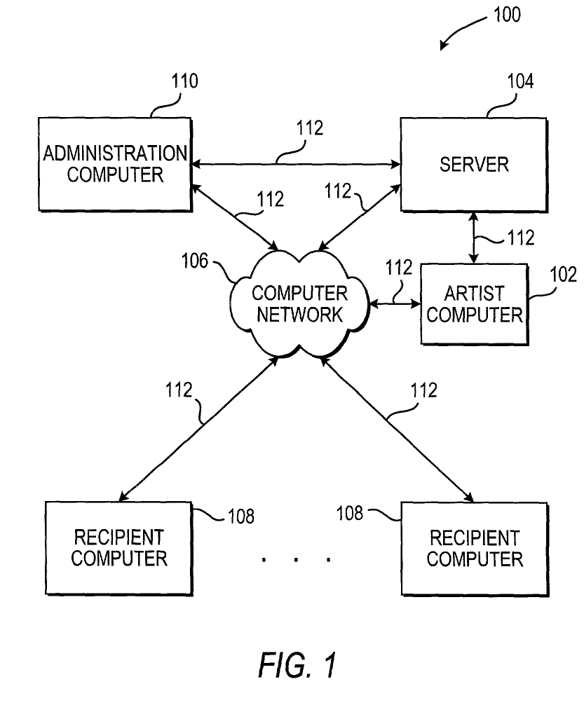

In connection with FIGS. 1-12, illustrative embodiments of the present invention are now discussed in more detail.

Turning first to FIG. 1, a system 100 for generating computer-displayed presentations in accordance with certain embodiments of the present invention is shown. As illustrated, system 100 may include an artist computer 102, a presentation server 104, a computer network 106, one or more recipient computers 108, an administration computer 110, and communication links 112.

Artist computer 102, presentation server 104, recipient computers 108, and administration computer 110 may be any suitable computing devices for performing the functions associated with those devices as described herein. For example, the devices may be desk-top computers, lap-top computers, hand-held computers, portable computers, computer workstations, mainframe computers, mini computers, distributed computers, portable telephones, television set-top boxes, or any other suitable devices. Although illustrated as part of system 100, administration computer 110 may be omitted if desired and the functionality of computer 110 moved into computer 102 and/or server 104 if needed. Similarly, server 104 may be omitted if desired and the functionality of server 104 moved into artist computer 102 if needed.

Computer network 106 may be any suitable computer network for transmitting data between artist computer 102, presentation server 104, recipient computers 108, and administration computer 110. For example, computer network 106 may be the Internet, an intranet, a local area network, a wide area network, a wireless network, a cable television network, a telephone network, a satellite network, or any other suitable network, or any combination of the same.

Communication links 112 may be any suitable links for connecting artist computer 102, presentation server 104, recipient computers 108, administration computer 110, and computer network 106. For example, links 112 may be hard-wired links, wireless links, dial-up connections, cable-modem links, digital subscriber line (DSL) links, or any other suitable links, or any combination of the same. As shown in FIG. 1, computers 102 and 110 are connected both to computer network 106 and to server 104. If desired, computers 102 and/or 110 may alternatively be connected to only one of network 106 and server 104.

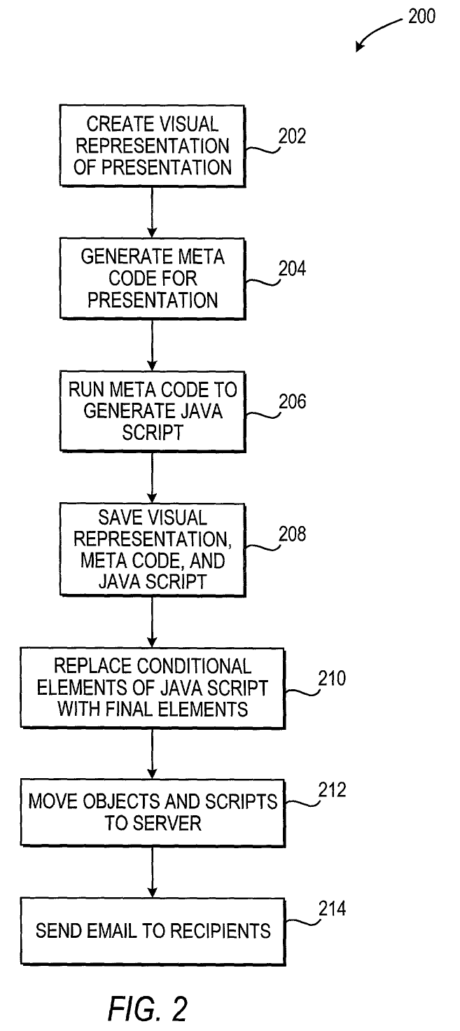

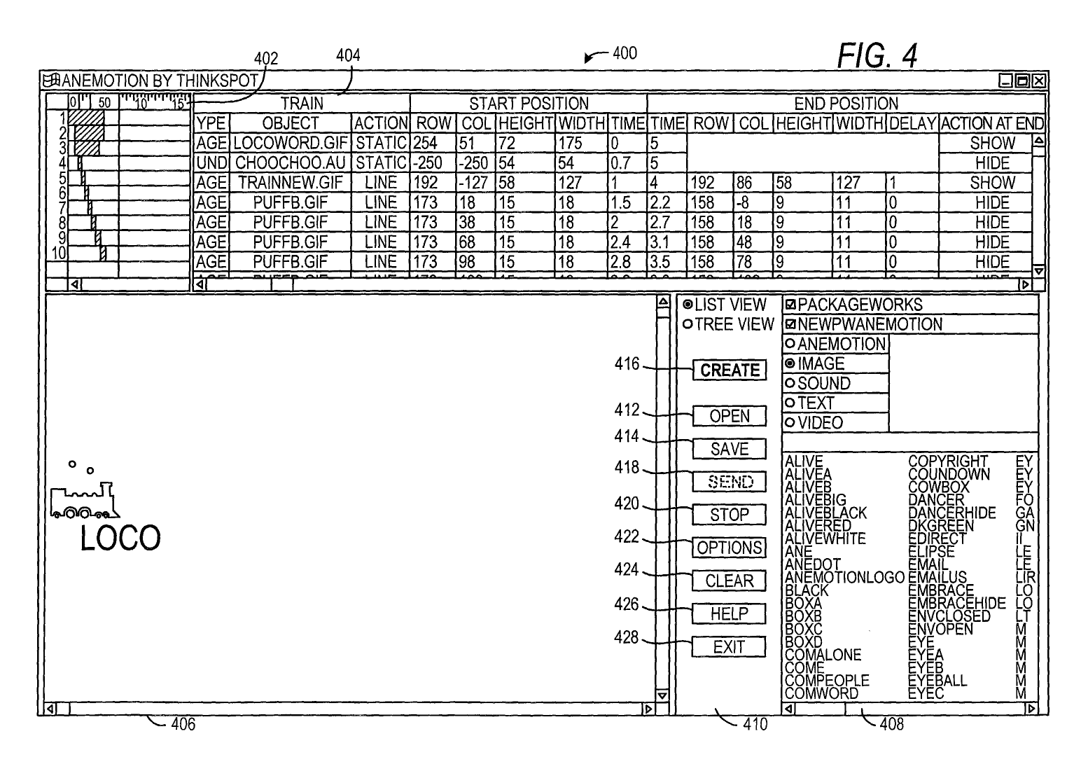

Referring now to FIG. 2, a process 200 in accordance with certain embodiments of the present invention for creating a presentation on an artist computer 102 and sending the presentation to one or more recipient computers 108 is shown. As illustrated, a visual representation of a presentation may first be created on an artist computer 102 at step 202. An example of a tool for creating such a presentation is discussed below and illustrated in FIGS. 4-11.

Once the presentation has been created, meta code for the presentation may be generated at step 204. The meta code preferably contains a set of instructions which define all aspects of the presentation and which may be used to generate Java script when executed. The meta code may be an executable APL function, although any suitable code or information may be used as meta code (APL is a programming language for which development tools and information are available from APL2000 Inc., Bethesda, Md.). Meta code may be generated in order to provide an intermediate level of output for debugging (or any other purpose) before generating Java script, or any other suitable email-client-executable or browser-executable code with similar capabilities, for the presentation.

Next, at step 206, the meta code may be run in order to generate Java script. An example of how the Java script may be created is discussed below. Because generation of the meta code is optional, steps 204 and 206 may be omitted if desired and the Java script (or other code) may be produced directly from the visual representation of the presentation.

After generating the Java script, process 200 may next save the visual representation, the meta code (if used), and the Java script to any suitable storage medium at step 208. Although saving of these items is shown in process 200 as being performed at step 208, the items may be saved at any suitable point or points within process 200.

When the person creating the presentation is ready to send the presentation to the recipients, process 200 may replace any conditional elements of the Java script with final elements at step 210. The conditional elements may be temporary file names, local network addresses, template fields in the presentation (like template fields in a word processing document using a mail merge function), etc. The final elements may be permanent file names, final Uniform Resource Locators, contents from an e-list to be substituted into template fields, etc.

In finalizing the Java script, the Java script is preferably compiled into a “.HTM” file which is then compiled into an ordinary email message that is Simple Mail Transfer Protocol (SMTP) compliant (See RFC-0821 from the Internet Engineering Task Force at www.ietf.org). Certain portions of the presentation may also be embedded int to the email (See RFC-2111 from the Internet Engineering Task Force at www.ietf.org).

Process 200 may then move the objects and scripts that will be necessary to effect the presentation from artist's computer 102 to presentation server 104 at step 212. The objects may include images, video clips, sound clips, graphics, text, or any other content, that may be used in the presentation. The scripts may be a copy of the Java script and any other scripts that are necessary to support the Java script after it is sent to recipient's computers 108.

Finally, at step 214, process 200 may send the presentation to the recipients by way of the email. Alternatively, an email may be sent with a link to a copy of the Java script on the presentation server or any other server.

In this way, a presentation can be sent to a recipient via an ordinary email message without requiring that the recipient have any special software plug-ins, without requiring any attachments to the email message, and without requiring any special programming to develop each presentation.

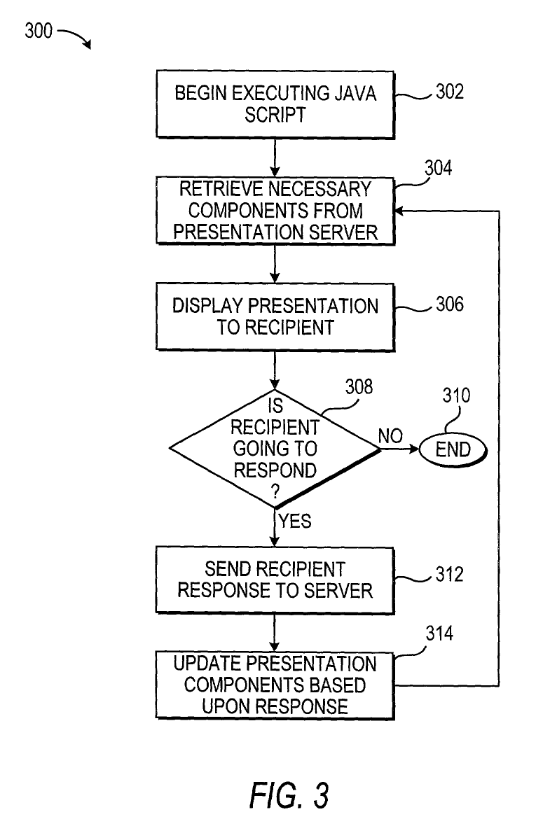

Turning to FIG. 3, a process 300 for displaying a presentation to a recipient in accordance with certain embodiments of the present invention is shown. As illustrated, once a recipient has opened an email (when Java script is included in the email) or opened the email and clicked on a link within the email including a presentation (when Java script is not included in the email) that points to a presentation, process 300 may begin executing the Java script at step 302. At step 304, process 300 may also retrieve any necessary components of the presentation from presentation server 104. As stated above, these components may include objects and/or scripts. At step 306, process 300 may display the presentation to the recipient. Displaying of the presentation may include executing various portions of the Java script and displaying still and/or animated images, pictures, graphics, video clips, audio clips, etc.

Once the recipient has viewed the presentation at step 306, process 300 may next determine at step 308 if the recipient is going to respond to the presentation. This determination may be based upon the availability of one or more response fields within the presentation, by the recipient responding to the presentation, or in any other suitable fashion. If the user is not going to respond, then process 300 may terminate at step 310. Otherwise, process 300 may send the recipient's response to presentation server 104 at step 312. Once the response has been received, server 104 may update the presentation contents based upon the recipient's response at step 314. After updating the presentation, process 300 may loop back to step 304 to retrieve the updated components of the presentation from server 104 at computer 108 and display those components at step 306.

An example of a user interface 400 for a tool for creating visual representations of a presentation in accordance with certain embodiments of the present invention is shown in FIG. 4. As illustrated, interface 400 may include a time line 402, a property sheet 404 (even as the time line or property sheet is scrolled up or down), an image viewer 406, a visual library 408, and a button bar 410.

As illustrated, time line 402 may include multiple rows and time marks in the horizontal dimension to indicate a time period for each row. Time line 402 preferably includes one row for each object in the presentation. The rows may be labeled with a number (or other symbol) as shown to indicate the corresponding object, or may be arranged to line up with the corresponding object shown in property sheet 404. There is preferably a one-to-one correspondence with each row in property sheet 404.

Within each row of time line 402, a rectangle may appear for the corresponding object to indicate its start time and end time. As illustrated, the start time is indicated by the left edge of the rectangle, and the end time is indicated by the right edge of the rectangle. If an object is selected, the rectangle in the corresponding row of time line 402 may turn blue in order to indicate that the object has the focus. Preferably, all rectangles that are not selected appear in gray. Preferably, the start time and the end time of a selected object can be changed by dragging blue dotted lines that may extend from each of the left side and the right side of the corresponding rectangle in the desired direction. Preferably, it may also be possible to drag a selected rectangle to a new time in order to change both the start time and the end time.

Also within time line 402, a vertical green line may be used to represent a start time or an instant in time, and a vertical red line may be used to represent an end time for various purposes as described below. For example, when a presentation is being set up, the green line may be used to represent the default start time of an object, and the red time may be used to represent the default end time of the object. The lines may be repositioned by clicking and dragging each line to the desired point in time line 402.

Between objects in time line 402, there may be a transition. The transition may provide a mechanism that links objects within a presentation or that invokes a special effect or a combination of special effects on one or more of the objects. The linking of objects allows the graphic user or the creative designer to change his or her mind based on how the presentation looks over time. For example, assume that an object A has dependent objects B and C. If the end time of object A is changed, then the start times of objects B and C and any of their dependent objects are also changed.

The special effects that may be invoked using a transition may include a time delay, an alpha control (including opacity, style, and position options), a blur control (including direction, strength, and effect options), a flip control (including a horizontal or vertical designation option), an X-Ray control, a chroma control (including a color option), a shadow control (including direction and color options), a drop shadow control (including offset and color options), a glow control (including color and strength options), a wave control (including strength, frequency, and wave options), a transition control (including duration, size, box, circle, wipe, dissolve, blinds, checkerboard, split, strips, random bars, and random options), and any other suitable special effects.

Other controls to objects that may be available through time line 402 may be accessed by right-clicking on the corresponding rectangle in time line 402. The controls include the option to delete the selected object, set an on-end event for the selected object (e.g., show, hide, display a Web address, initiate another presentation, etc.), set a mouse-click event for the selected object (e.g., display a Web address, initiate another presentation, display an image or video, or play a sound, etc.), set a mouse-over event for the selected object (e.g., display an image or text, or play a sound, etc.), set a mouse-out event for the selected object (e.g., reverse the mouse-over event, etc.), change a database field or a description associated with the selected object, elect whether to embed the selected object in an email, and any other suitable controls.

Property sheet 404 in interface 400 may be used to display information about various properties of each object in the presentation. Like time line 402, property sheet 404 may contain one row for each object, and properties for each object may be shown in columns within the property sheet. Because the properties displayed for an object in the property sheet control the behavior of the object, any change to these properties in the property sheet may alter how the object appears in time line 402 and image viewer 406.

Error checking may be provided to prevent inadvertent mistakes such as setting the end time for an object so that it is earlier that the object's start time.

For each object in property sheet 404, the following properties may be specified: the object Name; the display layer of the object (or z-order); the resource type of the object (i.e., whether the object is an image, text, sound, video, an edit box, a combo box, a check box, radio boxes, a submit button, etc.); the action associated with the object (e.g., static, hide, line, arc, oval, spiral, drawn path, etc.); the start traits of the object (e.g., position, size, time, etc.); the end traits of the object (e.g., position, size, time, delay at end, end event, etc.); the center position and the direction of rotation of the object (used for arcs and ovals); etc.

Image viewer 406 in interface 400 may provide a graphical interface for adding objects to a presentation and manipulating the properties of objects in a presentation. For example, a drag-and-drop operation to image viewer 406 may result in an object being added to time line 402 and property sheet 404. The start and end times assigned to an object are preferably based upon the current position of the green and red lines within time line 402 at the time the object is added. The start position assigned to an object is preferably the upper-left corner of the object where dropped. If the user selects a resource type of line, arc, oval, or spiral for an object, then a second image will preferably appear in image viewer 406 representing an end position for the object. The relative location of the second image may be set based upon a default configuration of interface 400. A dotted line from the start object (or start position) to the end object (or end position) is also preferably displayed in image viewer 406.

Once an object has been added, various properties of the object can be changed using image viewer 406. For example, both the start object and the end object can be resized by clicking on the bottom edge of the object to stretch or shrink it vertically, by clicking on the right edge of the object to stretch or shrink it horizontally, and by clicking on the bottom-right corner of the object to shrink or stretch it in both directions. Additionally, by holding down the shift key, while using these options, resizing of the object can be done proportionately. As an object is resized, the values representing the object's changing size preferably appear in the property sheet. Similarly, as another example, both the start object (or start position) and the end object (or end position) can be moved by clicking-and-dragging the object to any desired position, by clicking on the left edge of the object to move the object along the horizontal axis only, and by clicking on the top edge of the object to move the object along the vertical axis only. As an object is repositioned, the values representing the object's changing position preferably appear in the property sheet.

Other graphical editing interface features may also be provided in image viewer 406. For example, image viewer 406 may contain any number of horizontal and vertical guidelines which may be dragged from the left or top edges of the image viewer. As another example, upon right-clicking on the image viewer, a pop-up menu may be displayed that may be used to turn a snap-to-grid function on and off, cause a grid to be displayed, set icons to appear for sound, text, and video in the image viewer, and any other suitable editing features.

Image viewer 406 may also show the relative position of various objects in the presentation at any instant in time as identified by the green line in time line 402. For example, if the green line is positioned within time line 402 so that it crosses the rectangles of two objects, then those objects may be shown in image viewer at the positions corresponding to those objects at the time corresponding to the green line. Additionally, for any selected object, the movement line of that object may also be indicated in image viewer 406 when applicable. The focus of image viewer 406 (or the object selected within the image viewer) may be changed by clicking on the desire object.

Visual library 408 in interface 410 may be used to select objects to be included in a presentation. For example, in library 408, an object may be clicked-on to view or hear a preview of the object in a browser window or any other suitable manner, and then the object may be dragged into image viewer 406 to include the object in the presentation (as described above). Preferably, library 408 is configured similarly to a personal computer disk/folder/file structure.

Button bar 410 within interface 408 may be used to open an existing presentation or a new presentation, save a presentation, create Java script for a presentation, send a presentation, stop playback of a presentation, control options for a presentation, clear an option, receive help on how to operate interface 400, and exit interface 400.

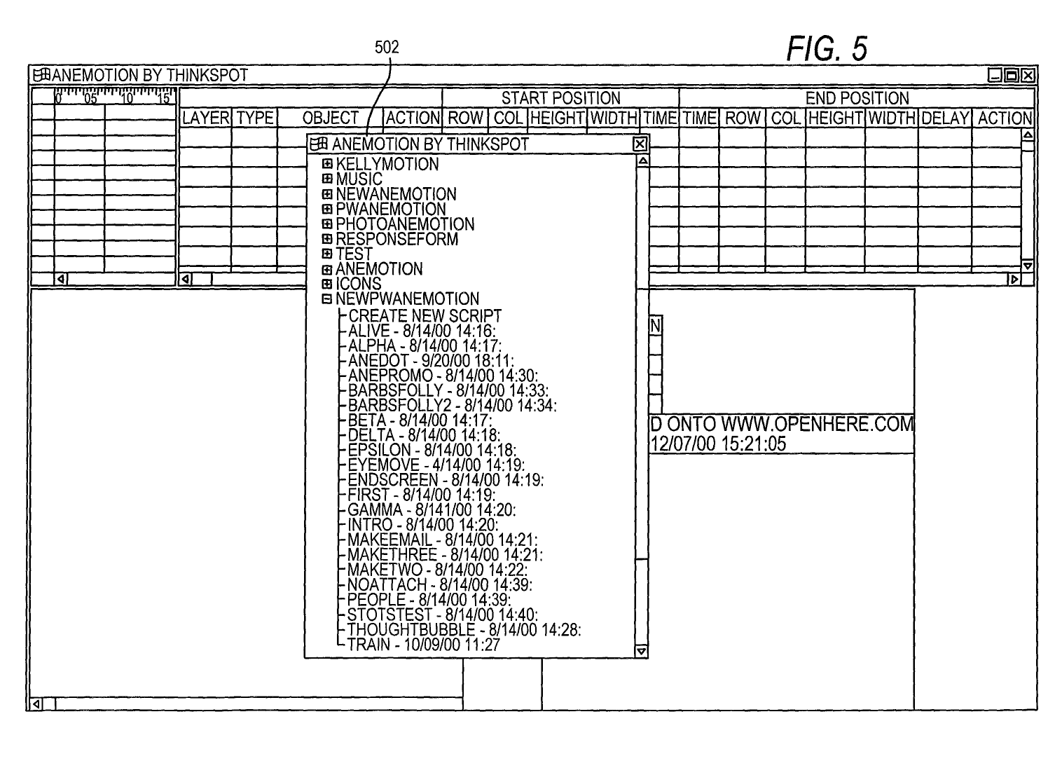

More particularly, upon pressing open button 412, an interface 502 may be presented that prompts the user to select an existing presentation or indicate that a new presentation is to be created as shown in FIG. 5. If an existing presentation is selected, then the presentation may be opened and loaded into interface 400. If a new presentation is to be created, the user may be prompted to select a client and a presentation name that are associated with the presentation, and then the presentation may be created.

Upon pressing save button 414, the visual representation for the current presentation and any meta code and/or Java script that have been created for the presentation may be saved to a storage medium. Preferably, the user is prompted to do this periodically to prevent an unintentional loss of data due to computer 102 being shut down accidentally, computer 102 crashing, etc. In certain embodiments of the invention, the user may be required to save a presentation before it can be sent to recipients. Information that may be saved may include: client name; presentation name; date modified; all information from time line 402, property sheet 404, and image viewer 406 (the visual representation); the meta code; the Java script; and any other suitable information related to the presentation or the default settings of interface 400.

Upon pressing create button 416, the visual representation of the presentation may be used to create the meta code and the Java script for the presentation. As explained above, the meta code may be an APL function that may then be executed to generate the Java script. The meta code preferably contains information for all of the properties of all of the objects contained in the visual representation of the presentation. Once created, the meta code may then be executed to create the Java script. The meta code may create the Java script using a Java script template that contains pre-written Java script for various type of display objects and display properties. The meta code may create the Java script from this template by copying the appropriate portions of the template and by substituting in information relating to objects that is particular to the presentation being created. For example, if an image file is being used in the presentation, and the image defined by that file is to be moved in a circle, an image file processing routine, a circle routine, and a main routine that accesses the image file processing routine and the circle routine may be used in the Java script.

Although, APL meta code and Java script are shown herein in order to describe the invention, it should be apparent to one of ordinary skill in the art that the present invention could be practice using any suitable meta code (or even none at all) and any suitable substitute for Java script.

When creating a presentation, the presentation may optionally only be prepared for that portion of the presentation between the green line and the red line of time line 402. This option may be useful to aid in development of various portions of the presentation without requiring creation and viewing of the entire presentation.

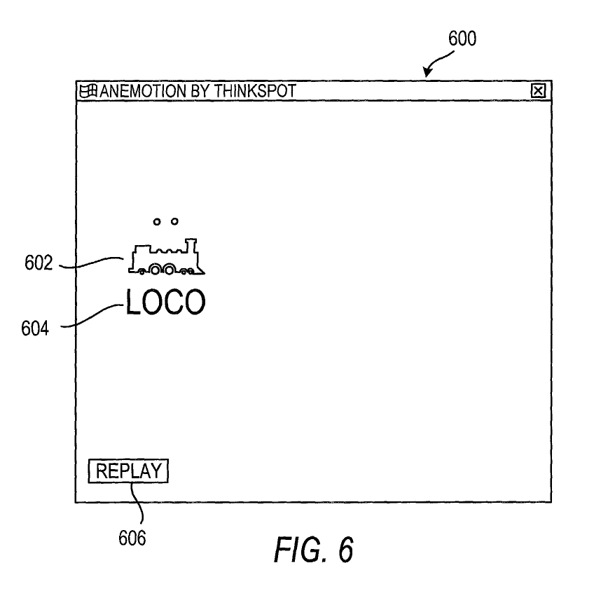

Upon creating a presentation, the presentation may automatically be displayed in a browser window 600 on artist computer 102 as shown in FIG. 6. Browser window 600 may be generated using any suitable browser software. As can be seen, browser window 600 may show various objects 602 and 604 and a replay button 606. Objects 602 and 604 are naturally a function of the presentation being created. Replay button 606 may be provided to allow a user to replay the presentation from the beginning to evaluate the user's satisfaction with the presentation. Turning back to FIG. 4, stop button 420 may also be used to stop the display or replay of the presentation in browser window 600 at any point.

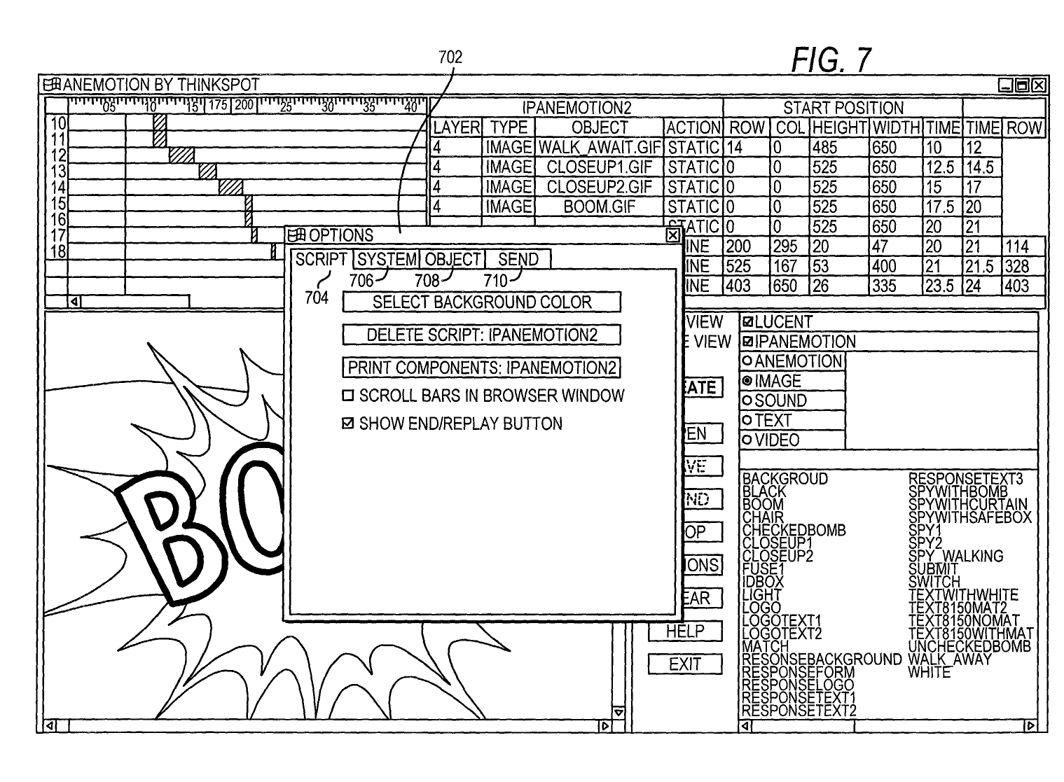

Upon options button 422 being pressed in interface 400, an options box 702 may be presented as shown in FIG. 7. As illustrated, options box 702 may include a script tab 704, a system tab 706, an object tab 708, and a send tab 710. As can be seen, script tab 704 may permit the user to select the background color for the script, delete the current script, print out the components of the current script, and select whether scroll bars are to appear in browser window 600.

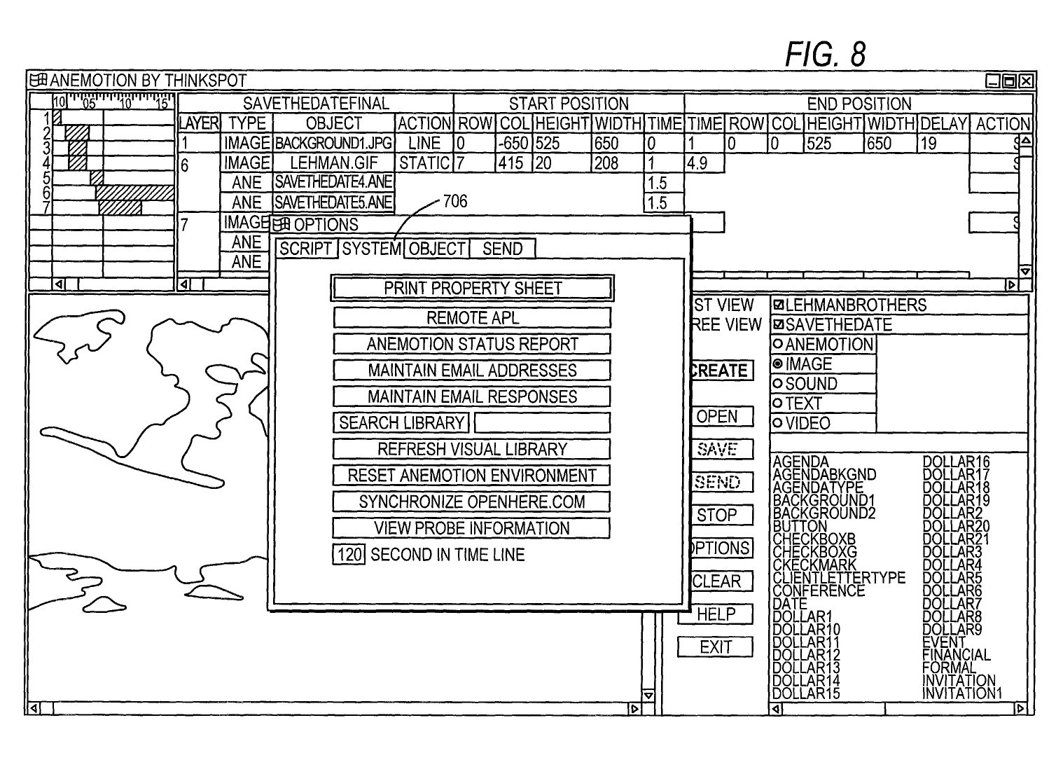

As shown in FIG. 8, system tab 706 may permit the user to print a property sheet for the presentation, activate a remote APL debugging tool, generate a presentation status report to show resources used by each presentation, maintain email addresses for recipients, maintain email responses to presentations, search the visual library for a specified term, refresh the contents of the visual library, reset interface 400 to its default settings, synchronize presentation server 104 with information on artist computer 102, view probe information that may indicate recipients' ability to view presentations, and specify the number of seconds shown in time line 402.

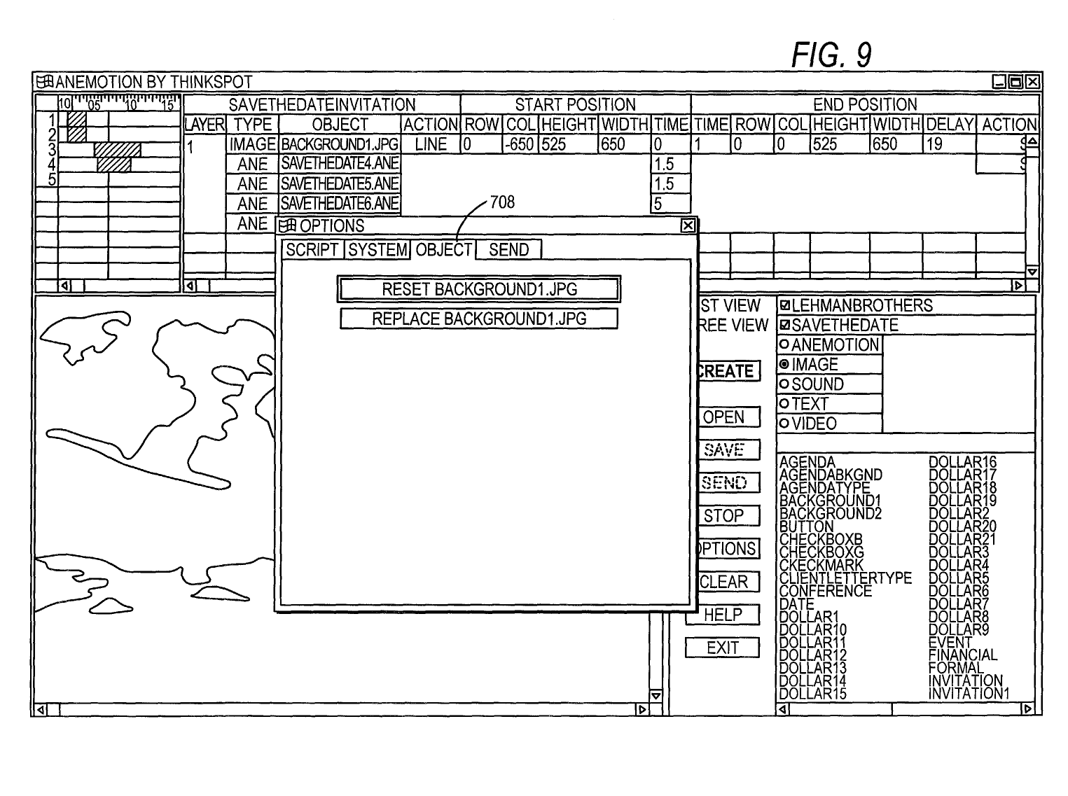

As shown in FIG. 9, object tab 708 may permit the user to reset a background image for a presentation to a default image and insert a new background image for a presentation.

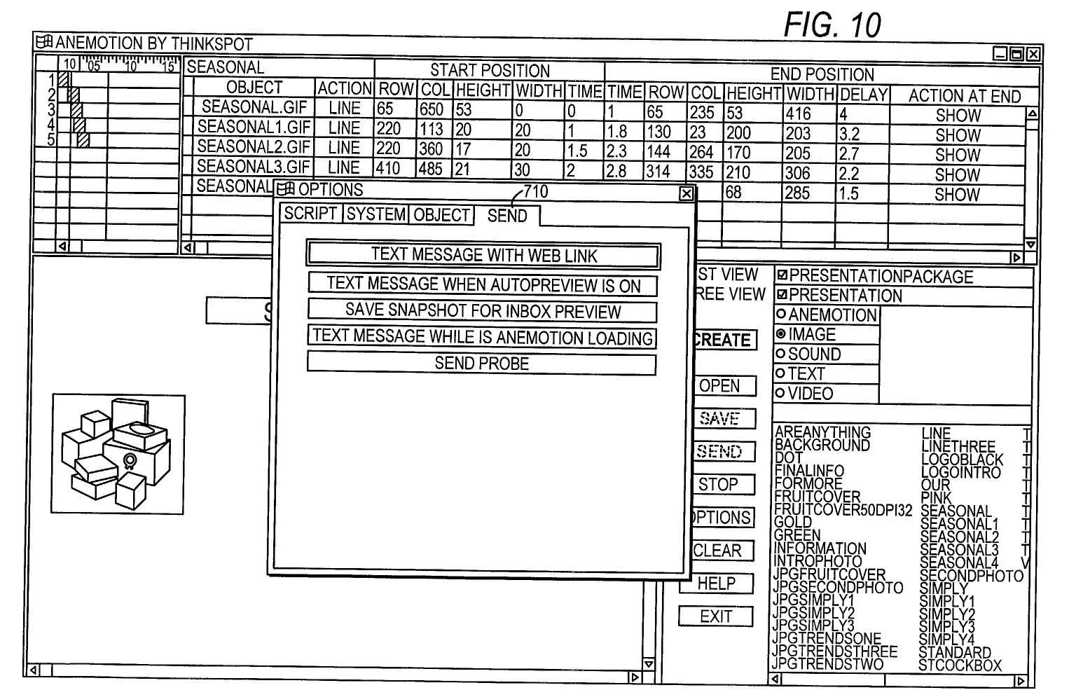

Finally, as shown in FIG. 10, send tab 710 may permit a user to select to send a text message with a web link rather than send a message with the Java script in the message, display a text message in the “auto-preview” window of certain email clients, save a snapshot that is to be displayed in the “auto-preview” window of certain email clients, display a text message while a presentation is loading components from presentation server 104 to recipient computer 108, and send a probe from presentation server 104 to recipient computer 108 to determine whether recipient computer 108 can display a presentation.

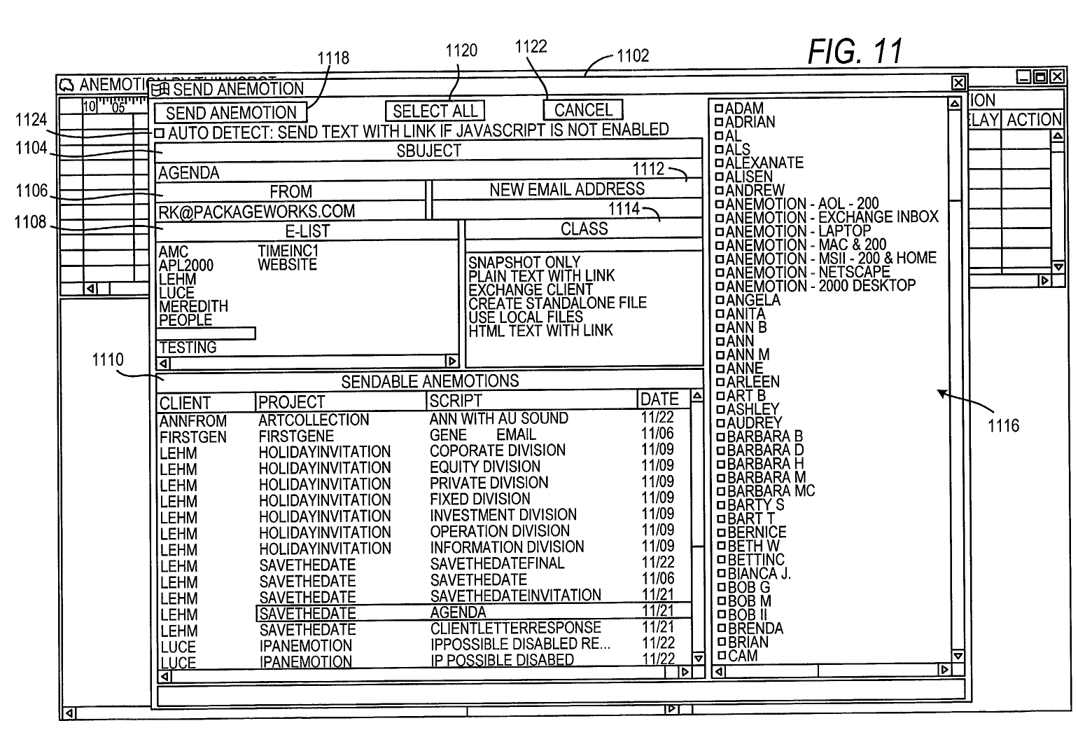

Upon a user selecting send button 418 in interface 400, a send window 1102 may be displayed as shown in FIG. 11. As illustrated, send window 1102 may permit a user to select a subject for a presentation to be sent in field 1104, indicate a return address for the presentation in field 1106, indicate to send the presentation to selected members in field 1116, add members to field 1116 using field 1112, indicate to send the presentation to members of an e-list selected in field 1108, select the presentation to be sent using field 1110, indicate whether to automatically send text with a link instead of Java script if Java script is not enabled on a recipient computer 108 by checking box 1124, send the presentation by pressing button 1118, select all members of field 1116 by pressing button 1120, and cancel out of window 1102 by pressing cancel button 1122. When an e-list is selected in field 1108, certain conditional elements in the Java script may be replaced with final elements from the e-list that may vary for each member of the e-list. This feature is similar to a mail-merge feature in a word processor.

Upon pressing clear button 424 in interface 400, the presentation in interface 400 may be cleared so that a new presentation can be created. In preferred embodiments, clear button 424 may ask the user whether the user would like to save the presentation before clearing the presentation.

Upon pressing help button 426 from interface 400, any suitable help information may be displayed to the user. This information may be a simple searchable help document, or may be an intelligent help agent that monitors what the user is trying to do prior to requesting help. The help information that is displayed may also be displayed using a web page or a presentation created using the present invention.

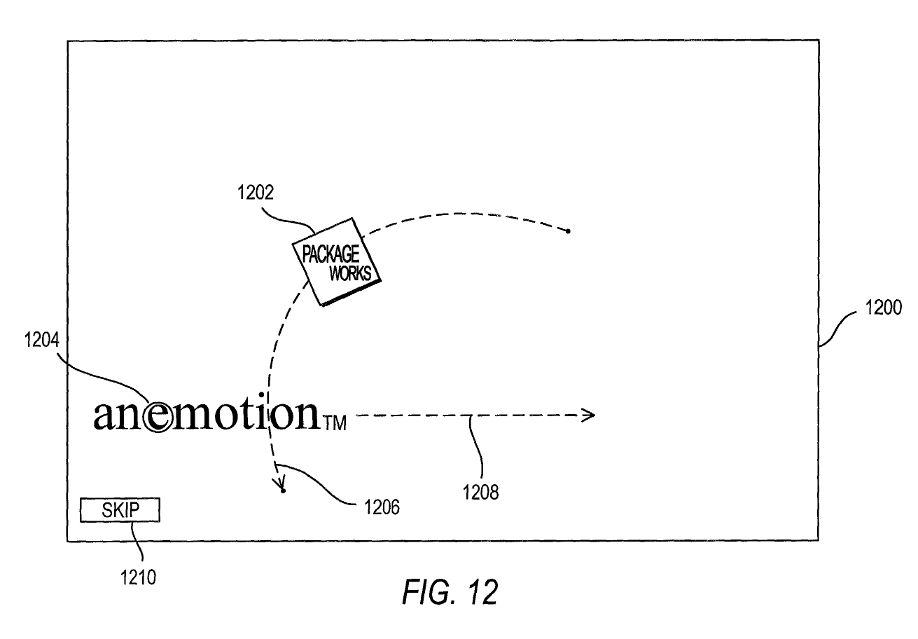

An illustration of a presentation as displayed upon a recipient opening an email containing the Java script for the presentation is shown in email client display window 1200 of FIG. 12. As illustrated, when the recipient opens the email, objects 1202 and 1204 may appear and move across window 1200 in the directions indicated by arrows 1206 and 1208. While the presentation is running (i.e., objects 1202 and 1204 are moving), button 1210 may act as a skip button to terminate the presentation. Once the presentation has stopped running, button 1210 may act as a replay button.

In order to facilitate automatic updating of a presentation sent to a user, the presentation may be designed so that objects are reloaded to a recipient's computer 108 from presentation server 104 every time that an email containing the presentation is opened by the recipient. For example, when a recipient receives a presentation to attend an event, upon the recipient completing the necessary information and pressing a submit button within the presentation, the presentation may automatically load another portion of the presentation from presentation server that includes a confirmation of the user's information.

Finally, upon pressing exit button 428 in interface 400, interface 400 will terminate. Like clear button 424, exit button 428 may ask the user whether the user would like to save the presentation before terminating the interface.

Thus, systems and methods for generating computer-displayed presentations are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for generating a presentation, comprising:
creating a visual representation of the presentation;
generating email-client-executable code corresponding to the visual representation;
sending email-client-executable code to a recipient computer as part of an email; and
causing the presentation to be displayed in response to the recipient opening the email.

2. The method of claim 1, wherein the email-client-executable code is Java script.

3. The method of claim 1, further comprising generating meta code corresponding to the visual representation.

4. The method of claim 3, wherein the meta code is an APL function.

5. The method of claim 1, further comprising replacing conditional elements of the email-client-executable code with final elements.

6. The method of claim 5, wherein the conditional elements are template fields.

7. The method of claim 5, wherein the final elements are content from an e-list.

8. The method of claim 1, further comprising causing components of the presentation to be retrieved from a presentation server at a recipient computer.

9. The method of claim 1, further comprising receiving a response to the presentation from the recipient.

10. The method of claim 9, further comprising updating the presentation based upon the response to the presentation.

11. The method of claim 1, further comprising embedding components of the presentation in the email-client-executable code.

12. The method of claim 1, wherein no plug-in software is required to be downloaded in order to display the presentation.

13. The method of claim 1, wherein the email does not have any attachments.

14. A system for generating a presentation, comprising:
an artist computer that creates a visual representation of the presentation, and that generates email-client-executable code corresponding to the visual representation; and
a recipient computer that receives the email-client-executable code as part of an email, and that displays the presentation in response to the recipient opening the email.

15. The system of claim 14, wherein the email-client-executable code is Java script.

16. The system of claim 14, wherein the artist computer also generates meta code corresponding to the visual representation.

17. The system of claim 16, wherein the meta code is an APL function.

18. The system of claim 14, wherein the artist computer also replaces conditional elements of the email-client-executable code with final elements.

19. The system of claim 18, wherein the conditional elements are template fields.

20. The system of claim 18, wherein the final elements are content from an e-list.

21. The system of claim 14, further comprising a presentation server that provides components of the presentation to the recipient computer.

22. The system of claim 21, wherein the presentation server also receives a response to the presentation from the recipient.

23. The system of claim 22, wherein the presentation server also updates the presentation based upon the response to the presentation.

24. The system of claim 14, wherein the artist computer also embeds components of the presentation in the email-client-executable code.

25. The system of claim 14, wherein the recipient computer does not download any plug-in software in order to display the presentation.

26. The system of claim 14, wherein the email does not have any attachments.
